(19) United States
(12) Patent Application Publication
(10) Pub. No.: US 2010/0125347 A1
(43) Pub. Date: May 20, 2010

(54) MODEL-BASED SYSTEM CALIBRATION FOR CONTROL SYSTEMS

(75) Inventors: G. Patrick Martin, Merritt Island, FL (US); Kathleen Minear, Palm Bay, FL (US); William C. Adams, JR., West Melbourne, FL (US)

Correspondence Address: HARRIS CORPORATION;C/O DARBY & DARBY PC, P.O. BOX 770, CHURCH STREET STATION, NEW YORK, NY, 10008-0770, US

(73) Assignee: Harris Corporation, Melbourne, FL (US)

(21) Appl. No.: 12/274,011

(22) Filed: Nov. 19, 2008

(51) Int. Cl. G05B 13/04; G06G 7/66; G06F 17/10

(52) U.S. Cl. 700/31; 703/6; 703/2

(57) ABSTRACT

A system and method for model-based control of a the physical system, based on a computer simulation model approximating operating characteristics of at least a portion of the plurality of components and having one or more model parameters for adjusting a modeled operating characteristic of at least one of the plurality of components is provided. In the system and method at least one active input parameter for the physical system is generated based on current values for the model parameters and the computer simulation model and at least one measured system parameter value and at least one modeled system parameter value are obtained for measuring the performance of physical system responding to the active input parameter. The system and method also evaluate a difference between the measured system parameter value and the modeled system parameter value and update the current values for the model parameters to minimize the difference.

### BACKGROUND OF THE INVENTION

1. Statement of the Technical Field

The invention concerns system calibration. More particularly, the invention concerns systems and methods for model-based calibration for control systems.

2. Description of the Related Art

In many physical systems, particularly electrical and mechanical, calibration data-based and model-based control systems are typically used. In the case of calibration data-based control systems, modern measurement tools permit precise measurements of the behavior of the physical system with reduced noise as compared to measurement systems available decades ago. In the case of model-based control systems, highly advanced mathematical descriptions of components are generally available that typically permit inclusion of effects that decades ago would have been neglected or roughly approximated due to the amount of computation intensity required. In some cases, the model predictions can be more accurate than experimental measurements of the physical system.

In either type of control system, the accuracy of control is limited by the accuracy of the model or the calibration data. In general, a physical system models is only as accurate as the parameters and/or assumptions initially input into the model. As a result, when a physical system is installed and used, the parameters or assumptions may no longer apply. Similarly, in the case of calibration data-based control systems, calibration measurements can become contaminated by numerous errors, which include biases and random noise. For example, inconsistencies between the actual performance of a physical system, such as a communications system, and the models or calibration data is generally due to component installation imperfections, varying signal-to-noise ratios, multipath signals, limited observation times, and non-optimum calibration signal sources. The result is a set of operational calibration measurements and/or models that are inaccurate and inaccurate operation of the physical system.

### SUMMARY OF THE INVENTION

Embodiments of the present invention systems and methods for model-based calibration of physical systems utilizing model-based control systems. In a first embodiment of the present invention, a method of using a model-based control system to control a physical system having a plurality of components is provided. The model-based control system is based on a computer simulation model of the physical system approximating operating characteristics of at least a portion of the plurality of components, the computer simulation model having one or more model parameters for adjusting a modeled operating characteristic of at least one of the plurality of components. The method includes generating at least one active input parameter for the physical system based on current values for the model parameters and the computer simulation model and obtaining at least one measured system parameter value and at least one modeled system parameter value for measuring the performance of physical system responding to the active input parameter. The method also includes evaluating a difference between the measured system parameter value and the modeled system parameter value and updating the current values for the model parameters to minimize the difference.

In a second embodiment of the present invention, a model-based control system for controlling a physical system having a plurality of components is provided. The control system includes a storage element for receiving a computer simulation model of the physical system, where the computer simulation model approximates operating characteristics of at least a portion of the plurality of components has one or more model parameters for adjusting a modeled operating characteristic of at least one of the plurality of components. The control system also includes a processing element for generating at least one active input parameter for physical system based on current values for the model parameters and the computer simulation model, where the processing element further includes a model-based calibration element for adjusting the current values for the model parameters based on a response of the physical system to the active input parameter. In the model-based calibration element, adjusting comprises obtaining at least one measured system parameter value and at least one modeled system parameter value for measuring the response of the physical system, evaluating a difference between the measured system parameter value and the modeled system parameter value, and updating the current values for the model parameters to minimize the difference.

In a third embodiment of the present invention, a communications system is provided. The communications system includes an array of antenna elements and a control system communicatively coupled to the array and generating control signals for the array. The control system includes a storage element for receiving a computer simulation model of the communications system approximating operating characteristics of the array of antenna elements and having one or more model parameters for adjusting a modeled operating characteristic of the array of antenna elements, and a processing element for generating the control signals for the array of antenna element based on current values for the model parameters and the computer simulation model. The processing element further includes a model-based calibration element for adjusting the current values for the model parameters based on a response of the array of antenna elements to the control signals. Adjusting in the model-based calibration element includes obtaining at least one measured system parameter value and at least one modeled system parameter value for measuring the response, evaluating a difference between the measured system parameter value and the modeled system parameter value, and updating the current values for the model parameters to minimize the difference based on an iterative analysis of the computer simulation model.

### BRIEF DESCRIPTION OF THE DRAWINGS

Embodiments will be described with reference to the following drawing figures, in which like numerals represent like items throughout the figures, and in which:

FIG. 1 is a schematic illustration of an exemplary model-based calibration system in accordance with an embodiment of the present invention.

FIG. 2 is a flowchart of steps in an exemplary method for operating an array of antenna element according to an embodiment of the present invention.

FIG. 3 is a schematic view of a computer system within which a set of instructions operate according to an embodiment of the present invention.

FIG. 4 is a schematic illustration of an exemplary communications system configured according to an embodiment of the present invention.

FIG. 5 is a block diagram of the element array control system shown in FIG. 4.

FIG. 6 is a block diagram of the transmit side of the system controller shown in FIG. 5 communicatively coupled to the RF equipment shown in FIG. 4.

FIG. 7 is a block diagram of the receive side of the system controller shown in FIG. 5 communicatively coupled to the antenna controllers shown in FIG. 4.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

As previously described, physical systems are generally controlled using either model-based approaches or calibration data-based approaches. In the case of calibration data-based control, control signals are generated based on a table of measurement values for each measurement parameter. Typically, these would be generated using a finite set of measurements over the range of the parameter of interest after installation of the physical system allowing the physical system to be calibrated to account for systematic variations due to installation or other local factors. In operation, response of the system for a particular parameter value would be obtained by table lookup. Response values for parameter quantities not measured are typically obtained by some type of interpolation using nearby measured points (e.g., Linear Interpolation, Cubic Spline, Fourier, or Polynomial expansions). However, the accuracy of a calibration data-based approach is limited by the fact that the accuracy of measured calibration values is limited by the noise inherent in physical system and the accuracy of the interpolation method. Therefore, if a set of calibration data is obtained that has a high degree of noise in the measured values, accurate control of the system is difficult.

In a model-based control system, the underlying function associated with the measured parameter may be well-defined, so noise is typically not an issue. Furthermore, since the control signals are based upon the underlying function, the need for interpolation is generally reduced or eliminated. However, in a model-based control system, the underlying function is generally responsive to one or more unknown parameters, typically based on an initial set of measurements performed during installation or initial calibration of the physical system. Consequently, any error in obtaining the initial calibration data and/or configuring the model-based control system can result in an inaccurate control of the system.

To overcome the limitations of conventional control system methods, embodiments of the present invention provide a model-based calibration systems and methods. That is, the systems and methods described herein utilized a model-based approach for control of the physical system, as described above, but model parameters are dynamically adjusted to improve the accuracy of the model. In particular, measured output parameters of the physical system are compared with estimated output parameters and based on their difference, updated model parameters are generated. Such an approach provides the advantages of low-noise and well-defined behavior of the physical system provided by model-based approaches and the ability to account for systematic variations in the installed physical system provided by calibration-data based approaches.

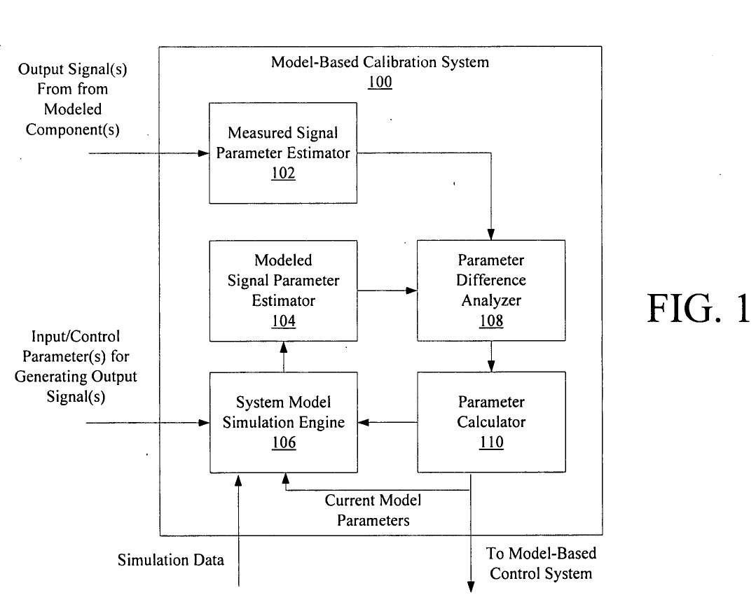

FIG. 1 is a schematic illustration of an exemplary model-based calibration system 100 in accordance with an embodiment of the present invention. The system 100 can include a measured signal parameter estimator (SPE) 102 for receiving output signals from the physical system. In the various embodiments of the present invention, the output signal can include not only an output signal associated with an end result of the physical system, but can also input output signals associated with one or more intermediate results of the physical system and/or measurements obtained from or at various components of the system. The measured SPE 102 can also generate or compute one or more system parameters for characterizing the physical system based on the output signals received by the measured SPE 102. For example, in a communications system using an array of antenna elements, measurements of signal phases or differences in signal phases at each of antenna elements can be received as output parameters. Consequently, the measured SPE 102 can generate system parameters based on such as signal covariance matrix coefficients, signal angle-of-arrival (AOA), or signal steering vectors, to name a few.

The system can also include a modeled SPE 104 for generating values for the same system parameters based on a modeled output signal generated by a system model simulation engine (SMSE) 106 in the system 100. The SMSE 106 is also configured to receive signals indicating the input or control parameters used for generating the output signals received by the measured SPE 102 and for receiving simulation data for generating the modeled output signal.

Input parameters for the SMSE 106 can include active input values provided to the system by a user or a particular component or function of the system. For example, in the case of a communications system comprising an array of antenna elements, input parameters can include amplitude, phase variation, azimuth, and elevation, to name a few. The input parameters can also include passive input parameters. Such passive input parameters can include, for example, environmental parameter values, such as temperature, pressure, and humidity, or other input parameters based on conditions in or around the physical system. However, embodiments of the present invention are not limited to solely for use with physical systems having the input parameters listed above. Rather, in the various embodiments of the present invention, the SMSE 106 can be used to simulate any type of systems affected by any number and type of input parameters, including biological, mechanical, chemical, or electromagnetic parameters.

As shown in FIG. 1, the SMSE 106 can also received simulation data. The simulation data received by the SMSE 106 can include a computer simulation model of the physical system and initial model parameters for the computer simulation model. In the various embodiments of the present invention, the computer simulation model can include models for describing the behavior of any number and types of components in the physical system, including components affected by biological, mechanical, chemical, or electromagnetic parameters. Accordingly, based on the computer simulation model and the input parameters for the output signal, the SMSE 106 estimates the output signals of the physical system for the modeled SPE 104.

The estimates of the system parameters generated by the measured SPE 102 and the modeled SPE 104 can then be compared in the parameter difference analyzer (PDA) 108. The PDA 108 calculates a difference between the modeled and measured values of the system parameters and provides the difference to the parameter calculator 110. For example, the PDA 108 may find a difference between measured and modeled signal strength and/or phase at a point between a control system and an antenna element in a communications system. The parameter calculator can then compute a new set of model parameters to minimize the differences computed at the PDA 108 so as to increase the accuracy of the model. That is, to adjust the model to improve agreement to the system parameters generated by the measured SPE 102. In some embodiments, the new model parameters can be directly calculated if the mathematical model of the physical system is sufficiently simple and the number of model parameters is sufficiently low. For example, in a physical system including only a few components, the model parameters can be directly calculated. However, as the complexity or non-linearity of the system increases, finding a solution using a direct method becomes increasingly computationally intensive and therefore impractical even when large computing resources are available. As a result, such complex systems generally require the use of iterative methods to find an approximate value for the model components, especially when the number of model parameters is large. That is, the model parameters are computed to minimize difference between the measured and modeled system parameters. In such embodiments, numerical gradient and steepest descent algorithms can be applied, to name a few.

The new model parameters generated by the parameter calculator 110 can then be provided to a control system (not shown) for generating new input parameters for the physical system. Additionally, the new model parameters are provided to the SMSE 106 to update the model being used for generating subsequent modeled output signals for the system 100. As a result, the model parameters controlling for the physical system are dynamically updated as additional output signals are generated by the system.

As a result, control of the physical system is provided that includes the benefits of calibration data-based control techniques (i.e., accounting for systematic variations in the behavior of the physical system) and model-based control techniques (i.e., well-defined system behavior). Furthermore, if the model parameters are allowed to be dynamically updated over a period of time, the model will become increasingly accurate over time. As a result, the amount of computations required during later updates of the model is significantly reduced and the physical system effectively operates as a purely model-based control system.

For example, a model-based calibration control was implemented for an exemplary interferometer system consisting of two microstrip patch antenna elements mounted on a large conical ground plane. In the exemplary system, the function describing the output power of the antenna elements was the electrical sum of the output power of the two elements as the incidence angle of the source was varied over a 65 degree azimuth range.

When such a system is controlled using a calibration data-based method, a large number of data points (typically tens of thousands of points) would need to be taken over the elevation and azimuth space of interest, each of which contains some amount of measurement error. As a result, the calibration data-based approach, as previously described, is limited by the accuracy of the measurements. A purely model-based control approach, based solely on pre-determined knowledge of the cone angle, the location of the elements on the cone, and the element patterns on a cone also provides only limited accuracy.

When a pre-defined model control system was applied, the measured and modeled output results varied significantly. Two model discrepancies primarily accounted for the difference between measured and modeled results: (1) the antenna element patterns did not include the effect of a conical ground plane, and (2) the locations of the elements were inaccurate in the model. Although the locations of the element could be more precisely measured to improve accuracy of the modeled output, these measurements will always include some amount of error. Furthermore, determining a correct value for the model parameters that account of the effect of the conical ground plane is non-trivial.

However, when utilized with a model-based calibration system in accordance with an embodiment of the present invention, the Present Inventors found that model parameters were quickly obtained that provided good agreement between modeled and measured output. During operation, the model-based calibration system initially adjusted element position parameters for the model of the interferometer system, which provided an improved agreement between measured and model results. As the number of data samples acquired was increased, even better agreement between measured and modeled output results were obtained as the model parameters were further adjusted. After these adjustments, the calibrated model predicted array performance in two scan dimensions (elevation and azimuth) with an insignificant amount of error as compared to calibration data-based or model-based control methods. Furthermore, once the model parameters were adjusted by the model-based calibration system, little or no additional adjustments to the model parameters were needed, reducing the need for iterative computations. Accordingly, the control system for the interferometer system was provided with a model calibrated with a substantially lower number of measurements than required for a calibration data-based approach. In general, the number of measurements needed for calibrating a model is dependent on the difference between the initial set of model parameters and the final set of model parameters. Therefore, the closer the approximation provided by the computer simulation model using the initial set of model parameters is to the actual output of the physical system, the lower is the number of measurements needed to obtain a final set of model parameters. In any case, the number of measurements needed for a model-based calibration in accordance with an embodiment of the present invention is at least one order of magnitude lower than the number of measurements required for a conventional calibration-based control system.

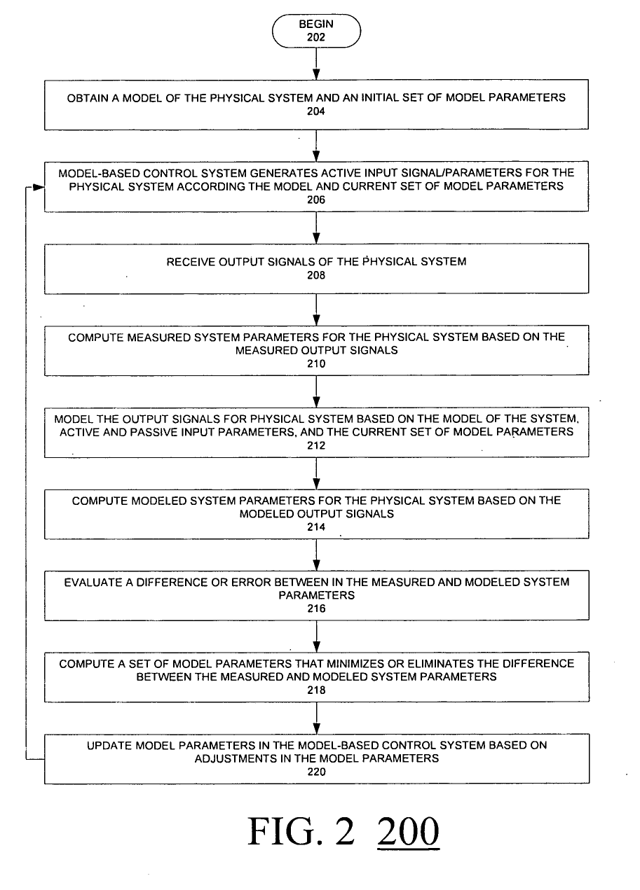

FIG. 2 is a flowchart of steps in an exemplary method 200 for operating a system using a model-based calibration technique in accordance with an embodiment of the present invention. The method can begin in step 202 can continue on to step 204. In step 204, an initial computer simulation model of the physical system to be controlled and an initial set of model parameters can be received. Using the computer model and current model parameters, a set of active input or control signals for the physical system can be generated at step 206.

At step 208, the output signals generated by the physical system in response to the active input signals generated at step 206 and any passive input control signals are measured. Afterwards, at step 210, the measured system parameters can be calculated from the output signals measured at step 208. Subsequently or in combination with step 208, modeled output signals are generated at step 212 and modeled system parameters are generated at step 214. The modeled output signal can be generated using a computer simulation model of the physical system using the input signals generated at step 206 and any other input signals (active or passive) or parameters affecting the physical system. The modeled system parameters can be generated at step 214 in the same way the measured system parameters are generated in step 210.

Once the measure and modeled system parameters are generated at steps 210 and 214, the difference between the parameters can be computed at step 216. That is, for each parameter being measured, the error in the model, due to the current set of model parameters, is calculated. Afterwards, in step 218, the adjustment needed for one or more model parameters is calculated to reduce the difference at step 216 is computed. As previously described, direct or iterative methods can be used at step 218, depending on the complexity of the physical system. The model parameters for the model of the physical system used by the control system for the physical system are then updated at step 220. The method 200 can then repeat starting at step 206, to provide further refinement of the model parameters based on subsequent performance of the physical system.

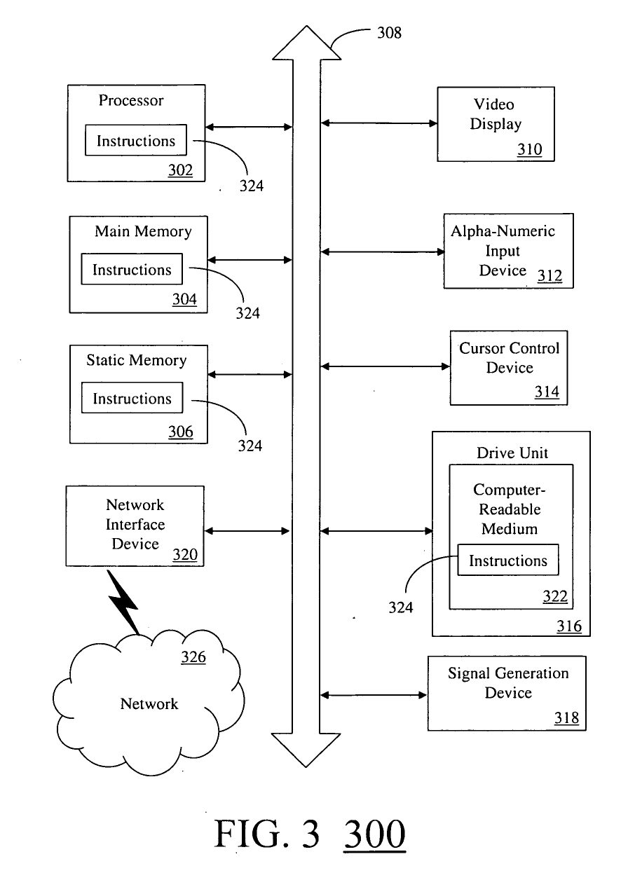

FIG. 3 is a schematic diagram of a computer system 300 for executing a set of instructions that, when executed, can cause the computer system to perform one or more of the methodologies and procedures described above. For example, the computer system can include functional or processing blocks associated with the various components in FIG. 1 or can include instructions for performing the various steps in FIG. 2. In some embodiments, the computer system 300 operates as a standalone device. In other embodiments, the computer system 300 can be connected (e.g., using a network) to other computing devices. In a networked deployment, the computer system 300 can operate in the capacity of a server or a client developer machine in server-client developer network environment, or as a peer machine in a peer-to-peer (or distributed) network environment.

The machine can comprise various types of computing systems and devices, including a server computer, a client user computer, a personal computer (PC), a tablet PC, a laptop computer, a desktop computer, a control system, a network router, switch or bridge, or any other device capable of executing a set of instructions (sequential or otherwise) that specifies actions to be taken by that device. It is to be understood that a device of the present disclosure also includes any electronic device that provides voice, video or data communication. Further, while a single computer is illustrated, the phrase “computer system” shall be understood to include any collection of computing devices that individually or jointly execute a set (or multiple sets) of instructions to perform any one or more of the methodologies discussed herein.

The computer system 300 can include a processor 302 (such as a central processing unit (CPU), a graphics processing unit (GPU, or both), a main memory 304 and a static memory 306, which communicate with each other via a bus 308. The computer system 300 can further include a display unit 310, such as a video display (e.g., a liquid crystal display or LCD), a flat panel, a solid state display, or a cathode ray tube (CRT)). The computer system 300 can include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 can include a computer-readable storage medium 322 on which is stored one or more sets of instructions 324 (e.g., software code) configured to implement one or more of the methodologies, procedures, or functions described herein. The instructions 324 can also reside, completely or at least partially, within the main memory 304, the static memory 306, and/or within the processor 302 during execution thereof by the computer system 300. The main memory 304 and the processor 302 also can constitute machine-readable media.

Dedicated hardware implementations including, but not limited to, application-specific integrated circuits, programmable logic arrays, and other hardware devices can likewise be constructed to implement the methods described herein. Applications that can include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the exemplary system is applicable to software, firmware, and hardware implementations.

In accordance with various embodiments of the present disclosure, the methods described herein can be stored as software programs in a computer-readable storage medium and can be configured for running on a computer processor. Furthermore, software implementations can include, but are not limited to, distributed processing, component/object distributed processing, parallel processing, virtual machine processing, which can also be constructed to implement the methods described herein.

The present disclosure contemplates a computer-readable storage medium containing instructions 324 or that receives and executes instructions 324 from a propagated signal so that a device connected to a network environment 326 can send or receive voice and/or video data, and that can communicate over the network 326 using the instructions 324. The instructions 324 can further be transmitted or received over a network 326 via the network interface device 320.

While the computer-readable storage medium 322 is shown in an exemplary embodiment to be a single storage medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable medium” shall accordingly be taken to include, but not be limited to, solid-state memories such as a memory card or other package that houses one or more read-only (non-volatile) memories, random access memories, or other re-writable (volatile) memories; magneto-optical or optical medium such as a disk or tape; as well as carrier wave signals such as a signal embodying computer instructions in a transmission medium; and/or a digital file attachment to e-mail or other self-contained information archive or set of archives considered to be a distribution medium equivalent to a tangible storage medium. Accordingly, the disclosure is considered to include any one or more of a computer-readable medium or a distribution medium, as listed herein and to include recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

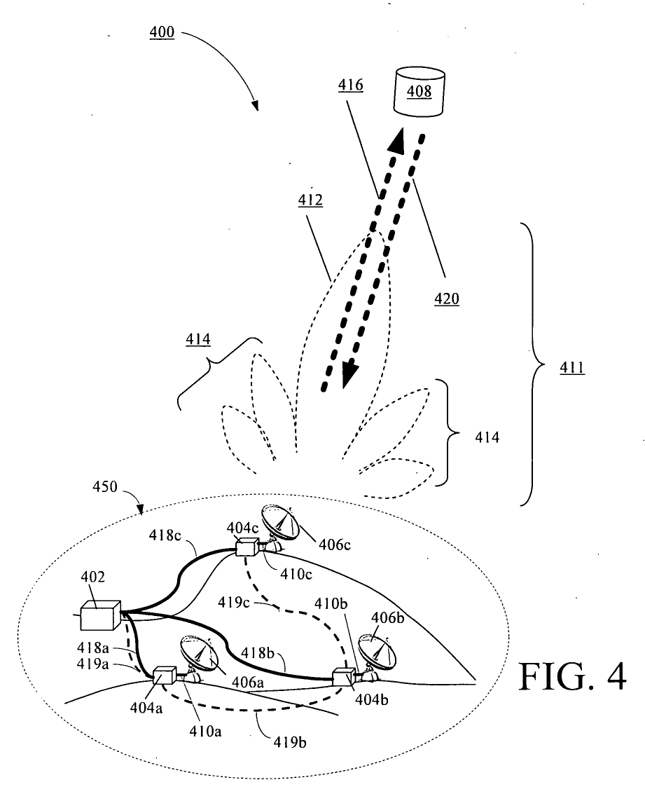

FIG. 4 shows an exemplary communications system 400 configured according to an embodiment of the present invention. As shown in FIG. 4, the communication system 400 comprises a multi-element antenna system (MEAS) 450 for transmitting signals to and receiving signals from at least one object of interest 408 remotely located from the multi-element antenna system. In FIG. 4, the object of interest 408 is shown as airborne or space borne object, such as an aircraft, spacecraft, a natural or artificial satellite, or a celestial object (e.g., planets, moons, asteroids, comets, etc. . . . ). However, the present invention is not limited in this regard and the MEAS 450 can also be used for transmitting and receiving signals from an object of interest 408 that is not airborne or space borne but is still remotely located with respect the MEAS 450. For example, a ground-based MEAS 450 can be used to provide communications with objects of interest 408 at other ground-based or sea-based locations.

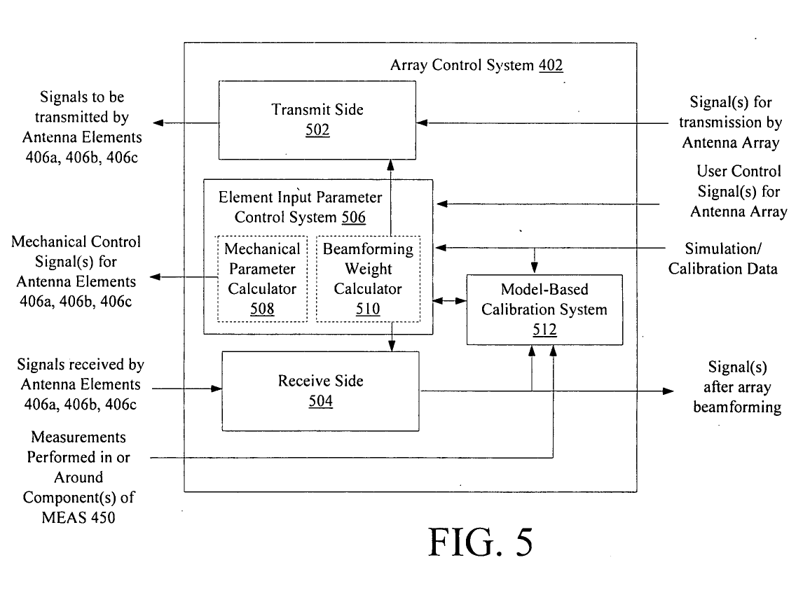

The MEAS 450 can generally include an array control system (ACS) 402 for controlling the operation of multiple antenna elements. In the exemplary system 400, the ACS 402 can include model-based calibration system for controlling operation of the MEAS 450, as described below in FIG. 5.

In FIG. 4, the ACS 402 is shown as controlling the operation of antenna elements 406a, 406b, 406c and associated RF equipment 404a, 404b, 404c. The antenna elements 406a, 406b, 406c provide wireless communications. For example, if the MEAS 450 is in a transmit mode, then each antenna element 406a, 406b, 406c converts electrical signals into electromagnetic waves. The radiation pattern 411 resulting from the interference of the electromagnetic waves transmitted by the different antenna elements 406a, 406b, 406c can then be adjusted to provide a central beam 412 in the radiation pattern 411 aimed in a direction 416 of the object of interest 408. The radiation pattern 411 of the antenna elements 406a, 406b, 406c also generates smaller side beams (or side lobes) 414 pointing in other directions with respect the direction of the central beam 412. However, because of the relative difference in magnitude between the side beams 414 and the central beam 412, the radiation pattern preferentially transmits the signal in the direction of the central beam 412. Therefore, by varying the phases and the amplitudes of the signals transmitted by each of antenna elements 406a, 406b, and 406c, the magnitude and direction of the central beam 412 can be adjusted. If the MEAS 450 is in a receive mode, then each of antenna elements 406a, 406b, and 406c captures energy from passing waves propagated over transmission media (e.g., air or space) in the direction 420 and converts the captured energy to electrical signals. In the receive mode, the MEAS 450 can be configured to combined the electrical signals according to the radiation pattern 411 to improve reception from direction 420, as described below.

In FIG. 4, the antenna elements 406a, 406b, and 406c are shown as reflector-type (e.g., dish) antenna elements, which generally allow adjustment of azimuth (i.e., lateral or side-to-side angle) and elevation (angle with respect to a local horizontal reference plane). Therefore, in addition to adjustment of phase and amplitude of the signal transmitted by each of antenna elements 406, the azimuth and elevation of each of antenna elements 406a, 406b, and 406c can also be used to further steer the central beam 412 and to further adjust the radiation pattern 411. However, the present invention is not limited in this regard and antenna elements 406 can comprise either directional or omni-directional antenna elements.

Although three (3) antenna elements 406a, 406b, 406c are shown in FIG. 4, the various embodiments of the present invention are not limited in this regard. Any number of antenna elements can be used without limitation. Furthermore, the spacing between the antenna elements 406a, 406b, and 406c with respect to each other can vary. Accordingly, the antenna elements 406a, 406b, and 406c can be widely or closely spaced to form an MEAS 450 that has a width of up to several kilometers. The antenna elements 406a, 406b, 406c can also be regularly spaced (not shown) with respect to one another to form a two dimensional (2D) grid of antenna elements or arbitrarily spaced (or non-linearly spaced) with respect to one another (as shown in FIG. 4) to form a three dimensional (3D) irregular array of antenna elements. As shown in FIG. 4, an arbitrary spacing for the antenna elements 406a, 406b, 406c can include providing varying elevation as well as varying lateral spacing between the antenna elements 406a, 406b, 406c.

As shown in FIG. 4, each of antenna elements 406a, 406b, 406c is communicatively coupled to a respective RF equipment 404a, 404b, 404c via a respective cable assembly 410a, 410b, 410c (collectively 410). Each of the cable assemblies 410a, 410b, 410c can have the same or different lengths. As used herein, the term “cable assembly” refers to any number of cables provided for interconnecting two different components. In the various embodiments of the present invention, the cables in the cable assembly can be bundled or unbundled.

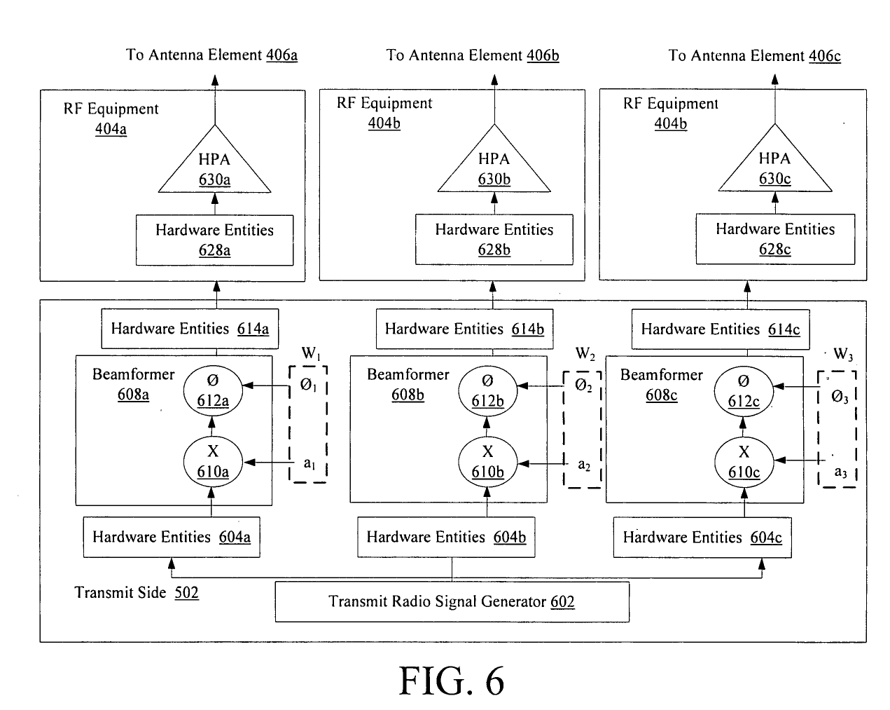

The RF equipment 404a, 404b, 404c control the antenna elements 406a, 406b, 406c, respectively. For example, the RF equipment 404a, 404b, 404c can include hardware entities for processing transmit signals and receive signals. The RF equipment 404a, 404b, 404c will be described in more detail below in relation to FIGS. 6-4. Additionally, for directional antenna elements, as shown in FIG. 4, the RF equipment 404a, 404b, 404c are configured to provide control signals for control antenna motors (not shown), antenna servo motors (not shown), and antenna rotators (not shown) in antenna elements 406a, 406b, 406c to provide, for example, azimuth and elevation control.

As shown in FIG. 4, each of the RF equipment 404a, 404b, and 404c is communicatively coupled to the ACS 402 via a respective communications links 418a, 418b, 418c. Generally such communications links are provided via a cable assembly, however the present invention is not limited in this regard. In the various embodiments of the present invention, communications links 418 can comprise wire line, optical, or wireless communications links. The cable assemblies for the communications links 418a, 418b, 418c can have the same or different lengths. Furthermore, although the communications links 418a, 418b, and 418c are shown to be arranged to couple the RF equipment 404 to the ACS 402 in parallel, in other embodiments of the present invention, they can be connected in a series arrangement, such as that shown by communications links 419a, 419b, and 419c.

In operation, the ACS 402 modulates signals to be transmitted by the antenna elements 406a, 406b, 406c. The ACS 402 also demodulates signals received from other antenna systems. The ACS 402 further controls beam steering. The ACS 402 will be described in more detail below in relation to FIGS. 5-7.

Referring now to FIG. 5, there is provided a more detailed block diagram of the ACS 402 in FIG. 4. As shown in FIG. 5, the ACS 402 includes a transmit side 502 and a receive side 504. The ACS 402 is be configured to manage both transmission and reception operations of the MEAS 450 based on signals for transmission and control signals. In particular, the transmit side 502 can generate signals to be transmitted by the RF equipment 404a, 404b, 404c via antenna elements 406a, 406b, 406c. Additionally or alternatively, the transmit side 502 can receive one or more signals from one or more signal generators (not shown) or receive external control signals. The transmit side 502 is also configured for modulating each of the generated or received signals and communicating the modulated signals to the RF equipment 404a, 404b, 404c for transmission. The transmit side 502 will be described in more detail below in relation to FIG. 6.

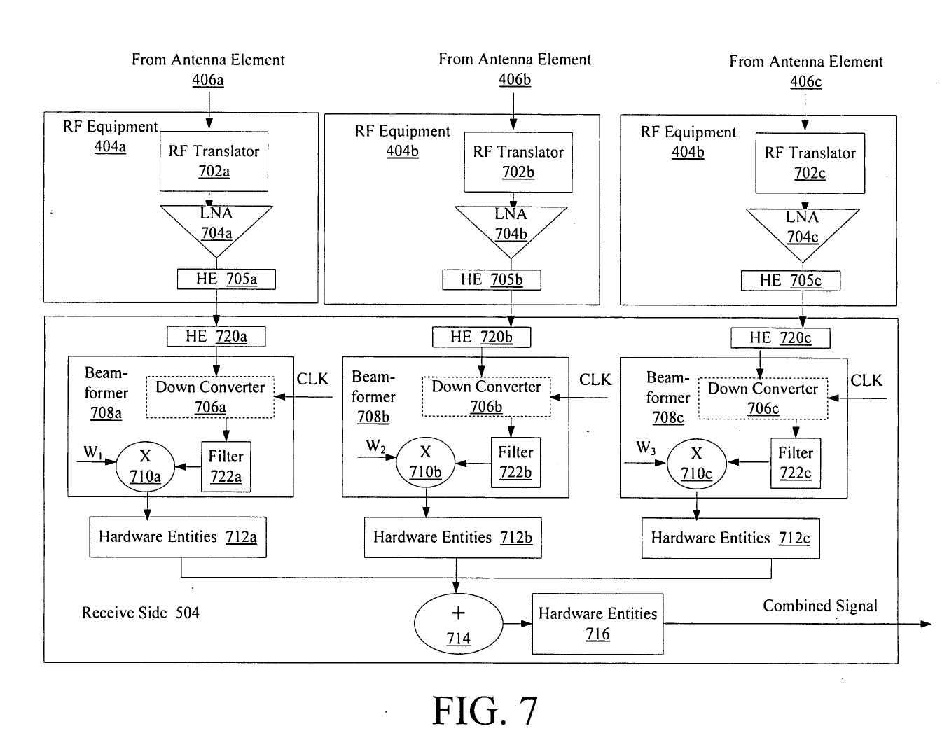

The receive side 504 is configured for receiving electrical signals generated by the RF equipment 404a, 404b, 404c based on the energy captured by the antenna elements 406a, 406b, 406c from passing waves. The receive side 504 is also configured for demodulating the electrical signal and communicating the demodulated electrical signal to an output device (not shown). The receive side 504 will be described below in more detail in relation to FIG. 7.

The exemplary ACS 402, as shown in FIG. 5, also includes a model-based calibration system (MBCS) 512 and an element input parameter control system (EIPCS) 508. The MBCS 512 in FIG. 5 is configured to receive simulation data, as previously described with respect to FIG. 1, including a computer simulation model of the MEAS 450 and an initial set of model parameters for the computer simulation model. The MBCS 512 in FIG. 5 can be configured to receive the signal received by the antenna elements before and/or after beamforming in the receive side. Additionally, the MBCS 512 can be configured to receive other input data from the MEAS 450 to utilize during modeling of output signals. For example, in the case of the MEAS 450, such measurements can include temperature measurements, signal phase measurements, or signal phase differences along different portions of the MEAS 450, to name a few. However, the other input data received by the MBCS 512 can also include any type of environmental, mechanical, or electromagnetic measurements performed in the MEAS 450. The MBCS 512 can be operated, as previously described with respect to FIG. 1, to provide updated model parameters for the EIPCS 506.

The EIPCS 506, operates as a model-based control system utilizing the model parameters provided by the MBCS 512 to control operation of the transmit side 502, the receive side 504, and other operations of the MEAS 450. The EIPCS 506 can receive control signals defining how the MEAS 450 is to be operated. For example, signals indicating a direction, frequency, or other transmission or reception parameters for the MEAS 450. Based on the control signals, the computer simulation model for the MEAS 450, and the current model parameters computed by the MBCS 512, the EIPCS 506 can generate the appropriate signals for the MEAS 450. For example, as shown in FIG. 5, the EIPCS 506 can include a mechanical parameter calculator 508 for generating signals for adjusting mechanical motion of components in the MEAS 450, such as an azimuth and elevation for the antenna elements 406a, 406b, 406c. The EIPCS 506 can also include a beamforming weight calculator 510 for computing weights for the transmit side 502 and/or the receive side 504. Operation of a beamforming weight calculator 510, based antenna system information from a model or calibration data is well-known to those of ordinary skill in the art and will not be described herein. Additionally, as the EIPCS 506 adjusts operation of the MEAS 450, the control signals generated by the EIPCS 506 can also be provided to the MBCS 512 in order to adjust the model parameters.

Referring now to FIG. 6, there is provided a block diagram of the transmit side 502 of FIG. 5 communicatively coupled to the RF equipment 404a, 404b, 404c of FIG. 4. As shown in FIG. 6, the transmit side 502 is comprised of a Transmit Radio Signal Generator (TRSG) 602, hardware entities 604a, 604b, 604c, and beamformers 608a, 608b, 608c. The TRSG 602 generates signals to be transmitted from the array of antenna elements 406a, 406b, 406c. The TRSG 602 is communicatively coupled to the hardware entities 604a, 604b, 604c. Each of the hardware entities 604a, 604b, 604c is communicatively coupled to a respective one of the beamformers 608a, 608b, 608c.

Each of the beamformers 608a, 608b, 608c can be utilized to control the phase and/or the amplitude of transmit signals for each antenna element 406a, 406b, 406c. In general, the respective phase shifts (Ø₁, Ø₂, Ø₃) and/or amplitude adjustments (a₁, a₂, a₃) for the antenna elements 406a, 406b, 406c can be used to adjust formation of the central beam 412, the side beams (or side lobes) 414 and nulls in the radiation pattern 411 of the MEAS 450. Nulls correspond to directions in which destructive inference results in a transmit signals strength that is significantly reduced with respect to the directions of the central beam 412 and the side beams 414. The combined amplitude adjustments a₁, a₂, a₃ and phase shift adjustments Ø₁, Ø₂, Ø₃ are referred to herein as a complex weight W₁, W₂, W₃. Each of the beamformers 608a, 608b, 608c combines a respective complex weight W₁, W₂, W₃ with the transmit signals to be provided to a respective RF equipment 404a, 404b, 404c. For example, as shown in FIG. 6, each beamformer 608a, 608b, 608c includes respective amplitude adjusters 610a, 610b, 610c for adjusting an amplitude of the transmit signals from hardware entities 604a, 604b, 604c, respectively, based on an amplitude a₁, a₂, a₃ Each beamformer 608a, 608b, 608c also includes phase adjusters 612a, 612b, 612c for applying adjusting a phase of the transmit signals from hardware entities 604a, 604b, 604c, respectively, based on a respective phase shift Ø₁, Ø₂, Ø₃. The amplitude a₁, a₂, a₃ and phase shift Ø₁, Ø₂, Ø₃ can be generated by the EIPCS 506.

In some embodiments of the present invention, the phase and amplitude adjusted signals from beamformers 608a, 608b, 608c can be communicatively coupled to the RF equipment 404a, 404b, 404c via one or more respective hardware entities 614a, 614b, 614c. The weighted transmit signals from beamformers 608a, 608b, 608c are received at a respective hardware entity 628a, 628b, 628c of the RF equipment 404a, 404b, 404c. The hardware entities 628a, 628b, 628c are communicatively coupled to a respective high power amplifier (HPA) 630a, 630b, 630c. HPAs are well known to those having ordinary skill in the art, and therefore will not be described herein. However, it should be understood that the HPAs 630a, 630b, 630c communicate signals to the antenna elements 406a, 406b, 406c for transmission therefrom in the direction 416 of an object of interest 408.

The term “hardware entity”, as used herein, refers to signal processing components, including but not limited to filters and amplifiers, and/or measurement components, such as environmental, physical, or electromagnetic sensor. In some embodiments of the present invention, hardware entities comprising measurement components can be coupled to the ACS 402 to provide input parameters for the MBCS 512 to generate system parameters. For example, hardware entities 614a, 614b, 614c and hardware entities 628a, 628b, 628c can comprise components for measuring a phase of the weighted signals at beamformers 608a, 608b, 608c and RF equipment 404a, 404b, 404c, respectively. The MBCS 512 can then adjust the model parameters based on a difference between measured differences and the modeled differences between the weighted signal phases at beamformers 608a, 608b, 608c and RF equipment 404a, 404b, 404c to provide a predictable weighted signal phase difference to improve operation of the EIPCS 506.

Referring now to FIG. 7, there is provided a block diagram of the receive side 504 of FIG. 5 communicatively coupled to the RF equipment 404a, 404b, 404c of FIG. 4. As shown in FIG. 7, each of the RF equipment 404a, 404b, 404c further comprises a Radio Frequency (RF) translator 702a, 702b, 702c and a Low Noise Amplifier (LNA) 704a, 704b, 704c. Each of the RF translators 702a, 702b, 702c performs signal frequency translation of receive signals from a respective antenna element 406a, 406b, 406c in the respective antenna controller 404a, 404b, 404c. The translation function of the RF translators 702a, 702b, 702c generally converts the received signal at a respective antenna element 406a, 406b, 406c from an RF to an intermediate frequency (IF). The LNAs 704a, 704b, 704c generally amplify the IF signals output from the RF translators 702a, 702b, 702c, respectively. Each of the LNAs 704a, 704b, 704c is communicatively coupled to the receive side 504 of the ACS 402. In some embodiments, the LNAs 704a, 704b, 704c are communicatively coupled to the receive side 504 of the ACS 402 via one or more hardware entities 705a, 705b, 705c.

The receive side 504 further includes a plurality of beamformers 708a, 708b, 708c and a signal combiner 714. The receive side can further include input hardware entities 720a, 720b, 720c and output hardware entities 712a, 712b, 712c for the beamformers 708a, 708b, 708c. As shown in FIG. 7, the input hardware entities 720a, 720b, 720c are communicatively coupled between the LNAs 704a, 704b, 704c and beamformers 708a, 708b, 708c. Each of the beamformers 708a, 708b, 708c can include a down converter 706a, 706b, 706c, a filter 722a, 722b, 722c, and a combiner 710a, 710b, 710c. Embodiments of the present invention are not limited in this regard. For example, the beamformers 708a, 708b, 708c can be absent of the down converters 706a, 706b, 706c and filters 722a, 722b, 722c.

Each down converter 706a, 706b, 706c can convert a digitized real signal centered at an IF to a basebanded complex signal centered at zero (0) frequency. The down converters 706a, 706b, 706c can share a common clock (not shown), and therefore receive the same clock (CLK) signal. The CLK signal can be generated within the receive side 504, elsewhere in the ACS 402, or external to the ACS 402. The down converters 706a, 706b, 706c can be set to the same center frequency and bandwidth. The down converters 706a, 706b, 706c can also comprise local oscillators that are in-phase with each other. This in-phase feature of the down converters 706a, 706b, 706c ensures that the down converters 706a, 706b, 706c shift the phases of signals by the same amount. After converting the digitized real signals to basebanded complex signals, the down converters 706a, 706b, 706c communicate the basebanded complex signals to the filters 722a, 722b, 722c, respectively. The filters 722a, 722b, 722c filter the basebanded complex signals and forward the same to the combiners 710a, 710b, 710c.

Each of the combiners 710a, 710b, 710c combines a basebanded complex signal with a complex weight W₁, W₂, W₃ for a particular antenna element 406a, 406b, 406c. The complex weights W₁, W₂, W₃ are selected to combine the receive signals according to a particular radiation pattern. That is, complex weights W₁, W₂, W₃ are selected to provide a central beam 412, side beams 414, and nulls, as described above, so as to preferentially receive signals from one or more preferred directions. The combiners 710a, 710b, 710c can include, but are not limited to, complex multipliers. Thereafter, the combiners 710a, 710b, 710c communicate the signals to the hardware entities 712a, 712b, 712c, respectively. The hardware entities 712a, 712b, 712c can further process the signals received from the beamformers 708a, 708b, 708c. The hardware entities 712a, 712b, 712c communicate the processed signals to the signal combiner 714.

At the signal combiner 714, the processed signals are combined to form a combined signal. The signal combiner can include, but is not limited to, a signal adder. Subsequent to forming the combined signal, the signal combiner 714 communicates the same to the hardware entities 716 for further processing. The hardware entities 716 can include, but are not limited to, filters and amplifiers. After processing the combined signal, the hardware entities 716 communicate the same to the demodulator for demodulation.

As previously described for FIG. 6, in some embodiments of the present invention, hardware entities comprising measurement components can be coupled to the ACS 402 to provide input parameters for the MBCS 512 to generate system parameters. For example, hardware entities 705a, 705b, 705c and hardware entities 720a, 720b, 720c can comprise components for measuring a phase of the weighted signals at RF equipment 404a, 404b, 404c and beamformers 708a, 708b, 708c, respectively. The MBCS 512 can then adjust the model parameters based on a difference between measured differences and the modeled differences between the weighted signal phases at beamformers 708a, 708b, 708c and RF equipment 404a, 404b, 404c to provide a predictable weighted signal phase difference to improve operation of the EIPCS 506.

Additionally, the receive signals can be utilized by the MBCS 512 to update model parameters to correct for errors in differential distances for the antenna elements. That is, individual variation in transmission path length for the antenna elements for a particular AOA with respect to a reference location. For example, based on the signal data associated with received signals, the MBCS 512 can be configured to calculate differential distances for the antenna elements for the AOA relative to a reference location. The MBCS 512 can also calculated the differential distances based on the configuration data and the AOA. The error between the values can then be used by the MBCS 512 to adjust the model parameters. Such errors can occur due to variations in the troposphere, errors in the placement of the antenna elements, or errors in the configuration data for the antenna elements. As a result, the analysis of such errors can lead to improved location information for the antenna elements or generation of addition phase and/or amplitude corrections during beamforming for transmitted signals.

Applicants present certain theoretical aspects above that are believed to be accurate that appear to explain observations made regarding embodiments of the invention. However, embodiments of the invention may be practiced without the theoretical aspects presented. Moreover, the theoretical aspects are presented with the understanding that Applicants do not seek to be bound by the theory presented.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. A method of using a model-based control system to control a physical system having a plurality of components, said model-based control system based on a computer simulation model of said physical system, said computer simulation model approximating operating characteristics of at least a portion of said plurality of components, said computer simulation model having one or more model parameters for adjusting a modeled operating characteristic of at least one of said plurality of components, the method comprising:
generating at least one active input parameter for said physical system based on current values for said model parameters and said computer simulation model;
obtaining at least one measured system parameter value and at least one modeled system parameter value for measuring the performance of physical system responding to said active input parameter;
evaluating a difference between said measured system parameter value and said modeled system parameter value; and
updating said current values for said model parameters to minimize said difference.

2. The method of claim 1, wherein said updating further comprises updating at least said current values for said model parameters associated with said measured system parameter value.

3. The method of claim 1, wherein said obtaining said measured system parameter value comprises:
measuring at least one output signal of said one of said plurality of components responsive to said active input parameter;
calculating said measured system parameter value based on said output signal.

4. The method of claim 3, wherein said obtaining said estimated parameter value comprises:
estimating said output signal using a computer simulation of said system, said computer simulation based at least on said computer simulation model, said current values for said model parameters, and said active input parameter;
calculating said modeled system parameter value based on said output signal estimated using said computer simulation.

5. The method of claim 4, wherein said computer simulation during said estimating said output signal is further based on at least one passive input parameter.

6. The method of claim 5, wherein said passive input parameter is at least one among a mechanical, a chemical, or an electromagnetic measurement performed in or around said physical system.

7. The method of claim 1, wherein said updating further comprises:
estimating one or more new values for at least one of said model components;
recomputing said difference for said new values; and
altering said current values for said model components based on a one of said new values minimizing said difference after said recomputing.

8. The method of claim 7, wherein said estimating, said recomputing and said altering are performed iteratively.

9. The method of claim 8, wherein said estimating said new values is based on a steepest descent algorithm.

10. A model-based control system for controlling a physical system having a plurality of components, the control system comprising:
a storage element for receiving a computer simulation model of said physical system, said computer simulation model approximating operating characteristics of at least a portion of said plurality of components, said computer simulation model having one or more model parameters for adjusting a modeled operating characteristic of at least one of said plurality of components; and
a processing element for generating at least one active input parameter for physical system based on current values for said model parameters and said computer simulation model, said processing element further comprising a model-based calibration element for adjusting said current values for said model parameters based on a response of said physical system to said active input parameter,
wherein said adjusting comprises obtaining at least one measured system parameter value and at least one modeled system parameter value for measuring said response of said physical system, evaluating a difference between said measured system parameter value and said modeled system parameter value, and updating said current values for said model parameters to minimize said difference.

11. The system of claim 10, wherein said processing element is further configured during said updating for updating at least said current values for said model parameters associated with said measured system parameter value.

12. The system of claim 10, wherein said model-based calibration element is configured during said obtaining said measured system parameter value for:
measuring at least one output signal of said one of said plurality of components responsive to said active input parameter;
calculating said measured system parameter value based on said output signal.

13. The system of claim 12, wherein said model-based calibration element is configured during said obtaining said estimated parameter value for:
estimating said output signal using a computer simulation of said system, said computer simulation based at least on said computer simulation model, said current values for said model parameters, and said active input parameter;
calculating said modeled system parameter value based on said output signal estimated using said computer simulation.

14. The system of claim 13, wherein said computer simulation in said model-based calibration element is further based on at least one passive input parameter.

15. The system of claim 14, wherein said passive input parameter is at least one among a mechanical, a chemical, or an electromagnetic measurement performed in or around said physical system.

16. The system of claim 10, wherein said model-based calibration element is configured during said updating for:
estimating one or more new values for at least one of said model components;
recomputing said difference for said new values; and
altering said current values for said model components based on a one of said new values minimizing said difference after said recomputing.

17. The system of claim 16, wherein said model-based calibration element performs said estimating, said recomputing and said altering iteratively.

18. The system of claim 17, wherein said estimating said new values is based on a steepest descent algorithm.

19. A communications system, comprising:
an array of antenna elements; and
a control system communicatively coupled to said array and generating control signals for said array, wherein said control system comprises:
a storage element for receiving a computer simulation model of said communications system, said computer simulation model approximating operating characteristics of said array of antenna elements, said computer simulation model having one or more model parameters for adjusting a modeled operating characteristic of said array of antenna elements; and
a processing element for generating said control signals for said array of antenna element based on current values for said model parameters and said computer simulation model, said processing element further comprising a model-based calibration element for adjusting said current values for said model parameters based on a response of said array of antenna elements to said control signals,
wherein said adjusting comprises obtaining at least one measured system parameter value and at least one modeled system parameter value for measuring said response, evaluating a difference between said measured system parameter value and said modeled system parameter value, and updating said current values for said model parameters to minimize said difference based on an iterative analysis of said computer simulation model.

20. The communications system of claim 19, wherein said processing element is further configured during said updating for updating at least said current values for said model parameters associated with said measured system parameter value.

21. The communications system of claim 19, wherein said model-based calibration element is configured during said obtaining said measured system parameter value for:
measuring at least one output signal of said one of said plurality of components responsive to said active input parameter;
calculating said measured system parameter value based on said output signal.

22. The communications system of claim 21, wherein said model-based calibration element is configured during said obtaining said estimated parameter value for:
estimating said output signal using a computer simulation of said system, said computer simulation based at least on said computer simulation model, said current values for said model parameters, and said active input parameter;
calculating said modeled system parameter value based on said output signal estimated using said computer simulation.

23. The communications system of claim 22, wherein said computer simulation in said model-based calibration element is further based on at least one of mechanical, a chemical, or an electromagnetic measurement performed in or around said array of antenna elements a system of using a model-based control system to control a physical system having a plurality of components is provided.
